(19) United States
(12) Patent Application Publication
(10) Pub. No.: US 2014/0071073 A1
(43) Pub. Date: Mar. 13, 2014

(54) FUEL DISPENSER HAVING ELECTROPHORETIC GRADE SELECT ASSEMBLY

(71) Applicant: Gilbarco Inc., Greensboro, NC (US)

(72) Inventors: RODGER K. WILLIAMS, Siler City, NC (US); Edward A. Payne, Greensboro, NC (US)

(73) Assignee: Gilbarco Inc., Greensboro, NC (US)

(21) Appl. No.: 14/022,510

(22) Filed: Sep. 10, 2013

Related U.S. Application Data
(60) Provisional application No. 61/698,905, filed on Sep. 10, 2012.

(51) Int. Cl. G06F 3/041; G09G 3/34

(52) U.S. Cl. CPC G06F 3/0412; G09G 3/344
USPC 345/173

(57) ABSTRACT

A selector assembly for a fuel dispenser comprises an electrophoretic display module including a price per unit display configured to display price per unit data. Also provided is an overlay attached to the electrophoretic display module so that the overlay is viewable by a user, the overlay defining a first window aligned with the price per unit display and a grade select button area. A touch screen is aligned with the button area of the overlay.

### PRIORITY CLAIM

The present application claims the benefit of U.S. Provisional Patent Application No. 61/698,905, filed Sep. 10, 2012, entitled “FUEL DISPENSER HAVING ELECTROPHORETIC GRADE SELECT ASSEMBLY,” the disclosure of which is hereby incorporated by reference as if set forth verbatim herein in its entirety and relied upon for all purposes.

### FIELD OF THE INVENTION

The present invention relates generally to fuel dispensers. More particularly, the invention relates to a fuel dispenser having a novel grade select assembly.

### BACKGROUND OF THE INVENTION

Several requirements related to fueling transactions necessitate that certain information be conveyed to a consumer during the transaction. This information may include the cost per unit of volume, the total volume, and/or the total cost of the fuel being dispensed. This information is generally financial in nature and related to a sale that is in progress, completed, or has been interrupted. As such, the weights and measures authority for the relevant jurisdiction typically mandates that the information remain readable for a minimum specified amount of time. One reason for this is to preserve the information in order to complete the transaction manually without dispute in the event of a power failure.

Fuel dispensers use various display technologies to convey the information to consumers during the fueling transaction, examples of which include mechanical, electromechanical segmented vane (“vane”), incandescent segmented filament (“filament”), heated cathode vacuum florescent (“florescent”), cold cathode gas discharge (“cathode”), light emitting diode (“LED”), and liquid crystal. There are generally two types of liquid crystal displays (“LCDs”): reflective and transmissive. Use of each type of display technology, however, is not without drawbacks.

Mechanical and vane displays suffer in reliability due to the number of moving parts required. Additional precision is accompanied by additional mechanical complexity and increased costs. The display's rate of computation is limited by friction, inertial mass, and other constraints attendant with physically moving parts.

Filament, florescent, and cathode displays require significant electrical power. For the same reason, maintaining display information during power loss requires a disproportionally large battery, capacitor(s), or other power supply. Filament displays suffer progressive degradation modes including filament sagging, oxidation, and sputtering, as well as absolute failure modes. Florescent displays degrade in their light output intensity over time as both cathode emissivity and phosphor anode efficiencies degrade. Cathode displays degrade in their light output intensity over time by both electrode sputtering and cathode poisoning. As a result, the ability to use a display of these types is reduced or eliminated over time.

LED displays may exhibit poor readability in sunlight and also require disproportionally large batteries to maintain display information during power loss. Due to their construction, LCDs attenuate total light throughput, which is worsened in the case of reflective-type LCDs due to the use of a reflector. Transmissive-type LCDs require a sufficient amount of rearward/backlighting in order to overcome direct sunlight exposure, as well as the above-mentioned attenuation, thereby increasing the electrical power required while reducing the useful life of the backlighting technology employed. As a result, the reliability of transmissive-type LCDs depends, at least in part, upon the source of the backlighting. A battery or other power source is required to maintain the backlighting during a power failure.

Additionally, each type of display described above requires a constant source of energy in order to operate, thereby increasing each dispenser's operational costs. Also for this reason, they are unable to display or provide any information in the absence of power. This is aggravated in certain areas where the supply of electric power is inconsistent or unreliable. Additional devices, such as capacitors, generators, and battery backups, may be used to continuously provide power to the displays in the event of a power failure, but installation, use, and maintenance of these devices also increases costs.

### SUMMARY

The present invention recognizes and addresses various considerations of prior art constructions and methods. According to one aspect, the present invention provides a selector assembly for a fuel dispenser. The assembly comprises an electrophoretic display module including a price per unit display configured to display price per unit data. Also provided is an overlay adjacent to the electrophoretic display module so that the overlay is viewable by a user, the overlay defining a window aligned with the price-per-unit display and further having a grade select button area. A touch screen panel is aligned with the button area of the overlay.

In some embodiments, the electrophoretic display module comprises a grade select display aligned with the grade select button area to display grade select activation data. The electrophoretic display module may further comprise an indicator display, and wherein the overlay further comprises an indicator display window aligned with the indicator display.

According to another aspect, the present invention provides a method of operating a fuel dispenser. The method involves providing a selector assembly including a selection device and an electrophoretic display module having a price-per-unit display. In addition, an overlay having a price-per-unit window and a grade select area is adjacent to the selection device and the electrophoretic display module so that the price-per-unit window is aligned with the price-per-unit display and the grade select area is aligned with the selection device. Another step of the method involves receiving input from a user of the fuel dispenser that the user has activated the selection device. Price-per-unit data is transmitted to the electrophoretic display module in response to a user activating the selection device. According to another step, the price-per-unit data received from the processor is displayed, at the price-per-unit display, in response to receiving the price-per-unit data.

Those skilled in the art will appreciate the scope of the present invention and realize additional aspects thereof after reading the following detailed description of preferred embodiments in association with the accompanying drawing figures.

### BRIEF DESCRIPTION OF THE DRAWINGS

A full and enabling disclosure of the present invention, including the best mode thereof directed to one of ordinary skill in the art, is set forth in the specification, which makes reference to the appended drawings, in which:

FIG. 1 is a diagrammatic representation of a retail fuel dispensing environment in which an embodiment of the present invention may be utilized.

FIG. 2 is a front elevational view of an exemplary fuel dispenser within the retail fueling environment of FIG. 1 that may incorporate a novel grade select assembly in accordance with the present invention.

FIG. 3 is a front view of a novel grade select assembly according to an embodiment of the present invention that may be utilized with the fuel dispenser of FIG. 2.

FIG. 4 is a diagrammatic view of an electrophoretic display module that may be utilized in the grade select assembly of FIG. 3 according to an embodiment of the present invention.

FIG. 5 is a front view of a single grade overlay for use with the electrophoretic display module of FIG. 4 according to an embodiment of the present invention.

FIG. 6 is an enlarged front view of an electrophoretic display module according to an embodiment of the present invention.

FIG. 7 is a cross-sectional view of the electrophoretic display module of FIG. 6.

FIG. 8 is a diagrammatic view of multiple electrophoretic modules connected to a control system of a fuel dispenser according to an embodiment of the present invention.

FIG. 9 illustrates a diagrammatic perspective view of a portion of a gradeselect assembly according to an embodiment of the present invention.

FIGS. 10A-10C illustrate exploded diagrammatic side views of the gradeselect assembly of FIG. 9 in alternative configurations.

FIG. 11 illustrates a front view of an overlay according to an embodiment of the present invention.

Repeat use of reference characters in the present specification and drawings is intended to represent same or analogous features or elements of the invention.

### DETAILED DESCRIPTION OF PREFERRED EMBODIMENTS

Reference will now be made in detail to presently preferred embodiments of the invention, one or more examples of which are illustrated in the accompanying drawings. Each example is provided by way of explanation of the invention, not limitation of the invention. In fact, it will be apparent to those skilled in the art that modifications and variations can be made in the present invention without departing from the scope or spirit thereof. For instance, features illustrated or described as part of one embodiment may be used on another embodiment to yield a still further embodiment. Thus, it is intended that the present invention covers such modifications and variations as come within the scope of the appended claims and their equivalents.

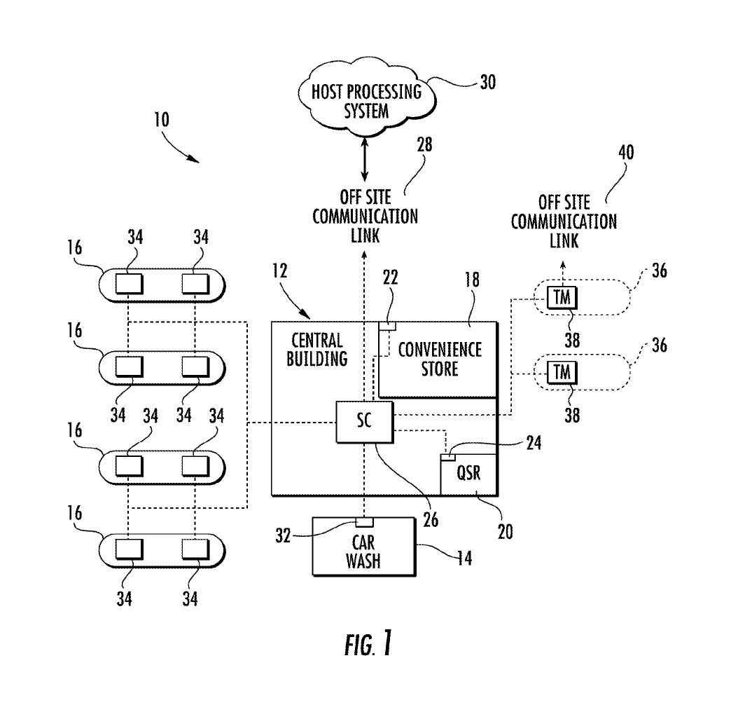

Embodiments of the present invention provide a fuel dispenser system having at least one user interface employing an electrophoretic display module or other substantially flat module that is capable of providing the desired functionality. A customer of the fuel dispenser selects a type or grade of fuel using a grade select feature on the user interface. In response to such selection, the associated electrophoretic display module activates a price-per-unit display area, an indicator area, and/or a gradeselect area of the electrophoretic display module. The customer is able to view these areas through respective windows or translucent areas of an overlay that is disposed over the electrophoretic display module. As the customer dispenses fuel, the display areas of the electrophoretic display module may change as necessary or desired (such as to present updated data to the customer) using electrophoretic display technology. Embodiments of the present invention are discussed in more depth below with regard to FIGS. 1-11.

Some embodiments of the present invention are particularly suitable for use with input devices in a retail service station environment, and the below discussion will describe preferred embodiments in that context. However, those of skill in the art will understand that the present invention is not so limited. In fact, it is contemplated that the present invention be used with any appropriate retail environment.

The term “layer” as used herein refers generally to one or more sheets, films, substrates, or the like. Thus, in some embodiments, a layer may comprise printed circuits, switches, or other electronic components, adhesives, insulating materials, shields, and/or sealants.

Referring now to FIG. 1, an exemplary fueling environment 10 may comprise a central building 12, a car wash 14, and a plurality of fueling islands 16. The central building 12 need not be centrally located within the fueling environment 10, but rather is the focus of the fueling environment 10, and may house a convenience store 18 and/or a quick serve restaurant 20 therein. Both the convenience store 18 and the quick serve restaurant 20 may include a point of sale (POS) 22, 24, respectively. POS 22, 24 may comprise a single computer or server operatively connected to an associated card reader and payment terminal. Additionally, POS 22, 24 may include a display, a touch screen, and/or other input devices.

The central building 12 may further house a site controller (SC) 26, which in an exemplary embodiment may be the PASSPORT® POS system, sold by Gilbarco Inc. of Greensboro, N.C., although third party site controllers may be used. Site controller 26 may control the authorization of fueling transactions and other conventional activities as is well understood, and site controller 26 may preferably be in operative communication with each POS. Alternatively, site controller 26 may be incorporated into a POS, such as point of sale 22, if needed or desired.

Further, site controller 26 may have an off-site communication link 28 allowing communication with a remote host processing system 30 for credit/debit card authorization, content provision, reporting purposes or the like, as needed or desired. In one embodiment, communication link 28 may be a stand alone router, switch, or gateway, although it should be appreciated that site controller 26 may additionally perform the functions of, and therefore replace, such a device. The off-site communication link 28 may be routed through the Public Switched Telephone Network (PSTN), the Internet, both, or the like, as needed or desired. Remote host processing system 30 may comprise at least one server maintained by a third party, such as a financial institution. Although only one remote host processing system 30 is illustrated, those of skill in the art will appreciate that in a retail payment system allowing payment via payment devices issued by multiple payment card companies or financial institutions, site controller 26 may be in communication with a plurality of remote host processing systems 30.

Car wash 14 may have a POS 32 associated therewith that communicates with site controller 26 for inventory and/or sales purposes. Car wash 14 alternatively may be a stand alone unit. Note that car wash 14, convenience store 18, and quick serve restaurant 20 are all optional and need not be present in a given fueling environment.

Fueling islands 16 may have one or more fuel dispensers 34 positioned thereon. Fuel dispensers 34 may be, for example, the ENCORE® fuel dispenser sold by Gilbarco Inc. of Greensboro, N.C. Fuel dispensers 34 are in electronic communication with site controller 26 through any suitable link, such as two wire, RS 422, Ethernet, wireless, etc. if needed or desired.

Fueling environment 10 also has one or more underground storage tanks (USTs) 36 adapted to hold fuel therein. As such, USTs 36 may each be a double walled tank. Further, each UST 36 may include a tank monitor (TM) 38 associated therewith. Tank monitors 38 may communicate with fuel dispensers 34 (either through site controller 26 or directly, as needed or desired) to determine amounts of fuel dispensed and compare fuel dispensed to current levels of fuel within USTs 36 to determine if USTs 36 are leaking.

Tank monitor 38 may communicate with site controller 26 and further may have an off-site communication link 40 for leak detection reporting, inventory reporting, or the like. Much like off-site communication link 28, off-site communication link 40 may be through the PSTN, the Internet, both, or the like. If off-site communication link 28 is present, off-site communication link 40 need not be present and vice versa, although both links may be present if needed or desired.

Further information on and examples of fuel dispensers and retail fueling environments are provided in U.S. Pat. No. 6,435,204 (entitled “Fuel Dispensing System”); U.S. Pat. No. 5,956,259 (entitled “Intelligent Fueling”); U.S. Pat. No. 5,734,851 (entitled “Multimedia Video/Graphics in Fuel Dispensers”); U.S. Pat. No. 6,052,629 (entitled “Internet Capable Browser Dispenser Architecture”); U.S. Pat. No. 5,689,071 (entitled “Wide Range, High Accuracy Flow Meter”); U.S. Pat. No. 6,935,191 (entitled “Fuel Dispenser Fuel Flow Meter Device, System and Method”); and U.S. Pat. No. 7,289,877 (entitled “Fuel Dispensing System for Cash Customers”), and U.S. Published Patent Application No. 2011/0273371, all of which are incorporated herein by reference in their entireties for all purposes. An exemplary tank monitor 38 may be the TLS-450 manufactured and sold by the Veeder-Root Company of Simsbury, Conn. For more information about tank monitors and their operation, reference is made to U.S. Pat. No. 5,423,457 (entitled “Real time tank product loss detection system”); U.S. Pat. No. 5,400,253 (entitled “Automated Statistical Inventory Reconciliation System for Convenience Stores and Auto/truck Service Stations”); U.S. Pat. No. 5,319,545 (entitled “System to Monitor Multiple Fuel Dispensers and Fuel Supply Tank”); and U.S. Pat. No. 4,977,528 (entitled “Apparatus and Method for Determining the Amount of Material in A Tank”), all of which are incorporated by reference herein in their entireties for all purposes.

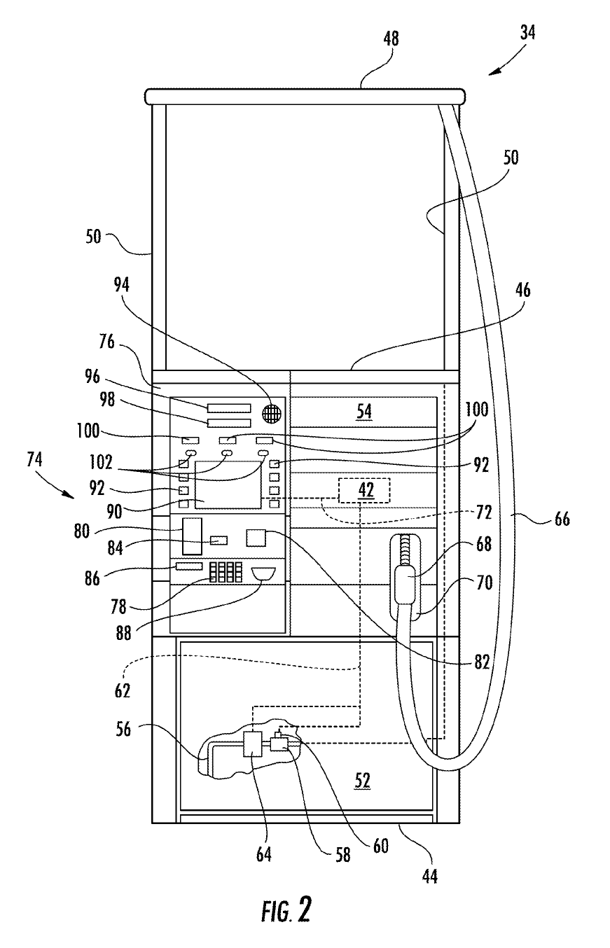

FIG. 2 illustrates a fuel dispenser 34 that may operate in association with site controller 26 according to an embodiment of the present invention. Dispenser 34 includes a control system 42, which may be a processor, microprocessor, controller, microcontroller, or other suitable electronics with associated memory and software programs running thereon. In a preferred embodiment, control system 42 is comparable to the microprocessor-based control systems used in CRIND and TRIND type units sold by Gilbarco Inc. Control system 42 is in operative communication with site controller 26. Control system 42 further controls various aspects of the fuel dispenser 34 as described in more detail below.

The memory of control system 42 may be any suitable memory or computer-readable medium as long as it is capable of being accessed by the control system, including random access memory (RAM), read-only memory (ROM), erasable programmable ROM (EPROM), or electrically EPROM (EEPROM), CD-ROM, DVD, or other optical disk storage, solid-state drive (SSD), magnetic disc storage, including floppy or hard drives, any type of suitable non-volatile memories, such as secure digital (SD), flash memory, memory stick, or any other medium that may be used to carry or store computer program code in the form of computer-executable programs, instructions, or data. Control system 42 may also include a portion of memory accessible only to control system 42.

In the illustrated embodiment, dispenser 34 has a base 44 and a top 46, with a canopy 48 supported by two side panels 50. Fuel dispenser 34 is subdivided into multiple compartments. In this regard, a hydraulic area 52 encloses hydraulic components and an electronic area 54 encloses electronic components. A vapor barrier may be used to separate the hydraulic area 52 from the electronic area 54.

Several components used to control fuel flow may be housed within the hydraulic area 52. Fuel from USTs 36 is pumped through a piping network into inlet pipe 56. Fuel being dispensed passes though a meter 58, which is responsive to flow rate or volume. A displacement sensor 60 (e.g., pulser) is employed to generate a signal in response to fuel flow though the meter 58. Signals indicative of the flow of fuel being dispensed are provided to control system 42 via control/data lines 62. Control/data lines 62 may provide control signaling to a valve 64 that may be opened and closed to permit or not permit dispensing of fuel.

Meter flow measurements from sensor 60 are collected by control system 42. Control system 42 also typically performs calculations such as cost associated with a fuel dispensing transaction. Additionally, control system 42 controls transactional processing at fuel dispenser 34 as will be described in more detail below.

As a dispensing transaction progresses, fuel is then delivered to a hose 66 and through a nozzle 68 into the customer's vehicle. Dispenser 34 includes a nozzle boot 70, which may be used to hold and retain nozzle 68 when not in use. Nozzle boot 70 may include a mechanical or electronic switch to indicate when nozzle 68 has been removed for a fuel dispensing request and when nozzle 68 has been replaced, signifying the end of a fueling transaction. A control line provides a signaling path from the electronic switch to control system 42. Control system 42 may use signaling received via this control line in order to make a determination as to when a transaction has been initiated or completed.

Control/data lines 72 provide electronic communication between control system 42 and a user interface 74. User interface 74 includes various combinations of subsystems to facilitate customer interaction with dispenser 34 and acceptance of payment for dispensed fuel. A bezel 76 acts as a lip around the various subsystems of interface 74. In most cases, bezel 76 is flush with the face of the fuel dispenser; however, in some embodiments it may extend outwardly from the face, in effect forming a raised lip. Bezel 76 may also comprise a plurality of sections that frame or house various subsystems or components.

As shown, user interface 74 includes several input devices. For example, user interface 74 may include a keypad 78. Keypad 78 is typically used for entry of a PIN if the customer is using a debit card for payment of fuel or other goods or services. In a preferred embodiment, keypad 78 may be the FlexPay™ encrypting PIN pad offered by Gilbarco Inc. User interface 74 may also include a card reader 80 for accepting credit, debit, or other chip or magnetic stripe cards for payment. Additionally, card reader 80 may accept loyalty or program-specific cards.

User interface 74 may also include other input devices such as a contactless card reader 82 (e.g., for integrated circuit or “smart” cards). Further, user interface 74 may include other payment or transactional devices such as a bill acceptor 84, a receipt printer 86, and a change delivery device 88. Receipt printer 86 may provide a customer with a receipt of the transaction carried out at fuel dispenser 34. Change delivery device 88 may deliver change to a customer for overpayment. Other transactional devices, such as an optical reader and a biometric reader, are also contemplated.

A display 90 may be used to display information, such as transaction-related prompts and advertising, to the customer. In some embodiments, a touch screen may be used for display 90. The customer may use soft keys 92 to respond to information requests presented to the user via the display 90. An intercom 94 may be provided to generate audible cues for the customer and to allow the customer to interact with an attendant. In addition, dispenser 34 may include a transaction price total display 96 that presents the customer with the price for fuel that is dispensed. A transaction gallon total display 98 may be used to present the customer with the measurement of fuel dispensed in units of gallons or liters. Octane selection “buttons” 100 may be provided for the customer to select which grade of fuel is to be dispensed before dispensing is initiated. Finally, price per unit (PPU) displays 102 may be provided to show the price per unit of fuel dispensed in either gallons or liters, depending on the programming of dispenser 34. When the customer selects one of the octane selection buttons 100, control system 42 receives data identifying the selected octane and instructs dispenser 34 to initiate dispensing of the selected fuel octane. Then, dispensing of the fuel may commence.

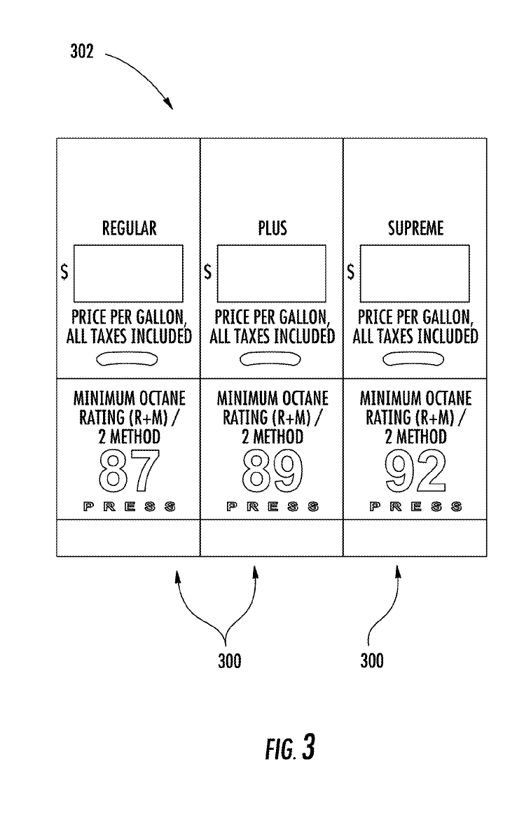

The present invention provides a novel grade select assembly and price-per-unit display which may be utilized in the fuel dispenser of FIG. 2. Referring now to FIG. 3, an embodiment of an improved grade select assembly in accordance with the present invention is illustrated. As will be described, PPU display 102 and octane selection buttons 100 may be incorporated into a grade select assembly (or selector) 300 in accordance with the present invention. Since each dispenser 34 may have multiple grade selection options, the fuel dispenser may include several separate grade select assemblies 300. Alternatively, several grade select assemblies 300 may be integrated into a larger grade select panel 302. Grade select assemblies 300 may be located at any appropriate location on dispenser 34, such as below display 90.

Each grade select assembly 300 is illustrated in the Figures as rectangular. However, it should be understood that one or more of the assemblies 300 may take various shapes, such as triangular or circular. Also, in addition to octane selection button 100 and PPU display 102, each assembly 300 may also include an indicator display.

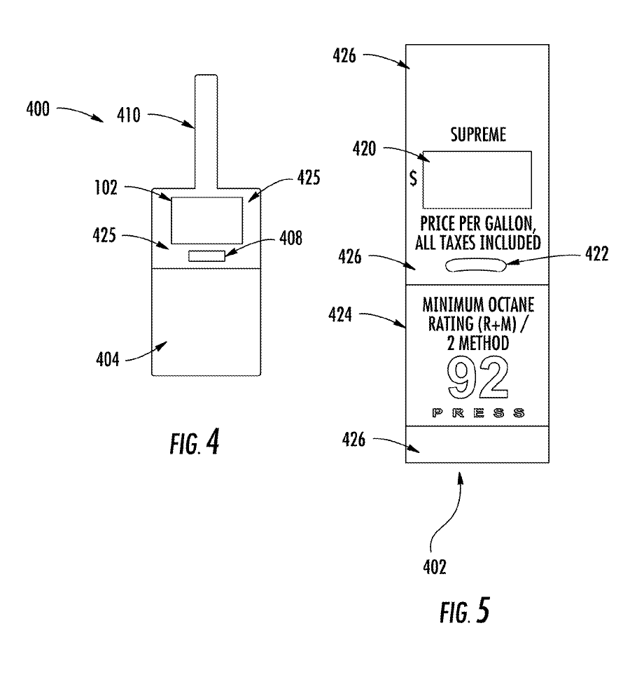

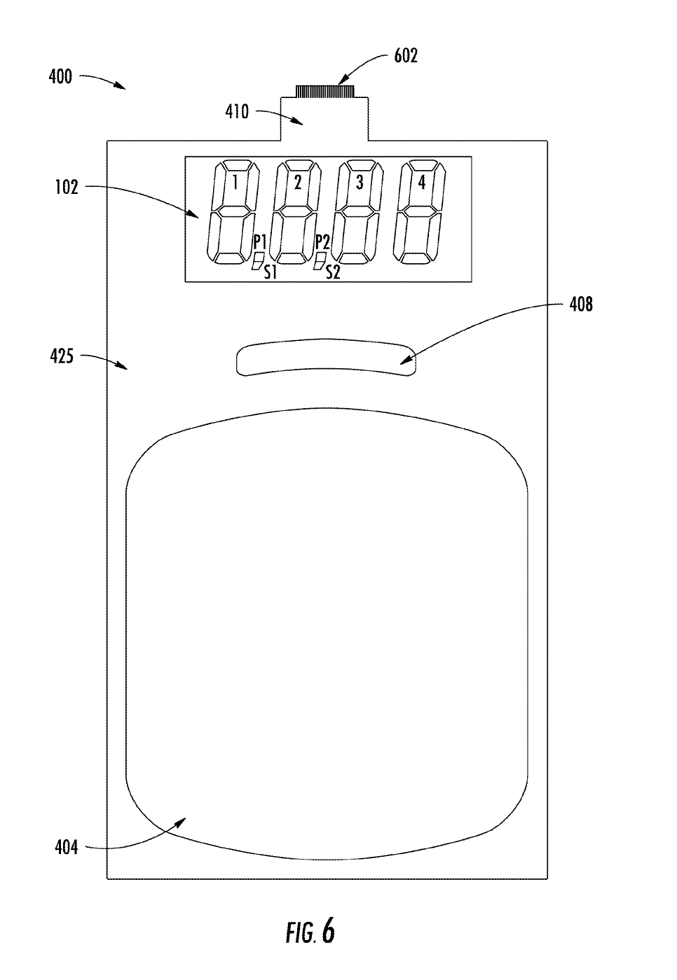

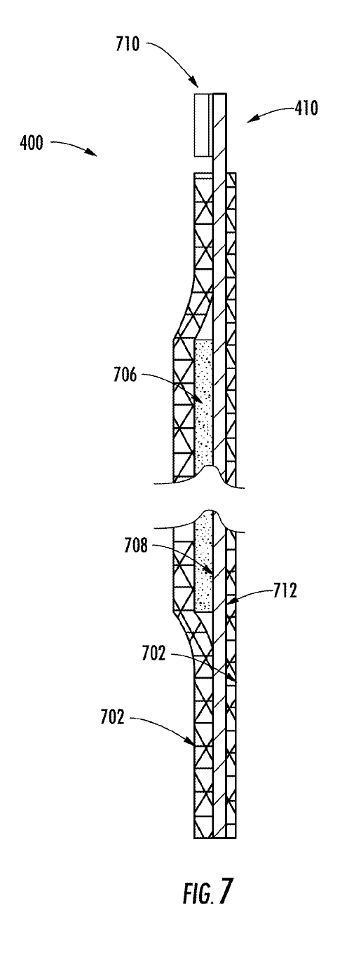

FIGS. 4-7 illustrate various components of a grade select assembly 300 according to an embodiment of the present invention. In this regard, FIGS. 4 and 6 illustrate an electrophoretic display module of one assembly 300 according to some embodiments. FIG. 5 illustrates an overlay member which may be disposed over the display module. FIG. 7 is a diagrammatic cross-section of the layers of the electrophoretic display module of FIG. 6, according to an embodiment.

As shown in FIGS. 4 and 5, each assembly 300 may include an electrophoretic display module 400 and an overlay 402. An electrophoretic display forms visible images by rearranging charged pigment particles using an applied electric field. The electric field manipulates the particles so that they either migrate to the surface of the display or rest near the rear of the display. As a result, an image is created and presented on the display. An electrophoretic display continues to display the image even after the electric field is withdrawn until another electric field is applied to the display in order to rearrange the particles. Electrophoretic displays are discussed in more detail in U.S. Pub. Pat. App. No. 2011/0273371, which is herein incorporated by reference in its entirety for all purposes.

Display module 400 includes one or more display areas. For example, as shown in FIG. 4, module 400 includes a gradeselect display 404, a PPU display 102 and/or an indicator display 408.

Gradeselect display 404 may form a portion of octane selection button 100. In this regard, gradeselect display 404 may present information relating to the type or grade (octane) of fuel that is associated with the particular octane selection button 100. For example, gradeselect display 404 may display “92” to indicate that the fuel octane associated with the octane selection button 100 is 92 octane fuel. In another embodiment, overlay 402 may define window areas forming numerals for the particular grade associated with a certain octane selection button 100. Alternatively, indicia indicating the octane may be printed on overlay 402 in a translucent area thereof. When a customer has selected the particular octane selection button 100, for example, grade select display 404 is activated to change from white (or other color) to black (or any other color) to affirm the customer's selection.

PPU display 102 shows the price per unit of fuel dispensed in either gallons or liters. As illustrated in FIG. 6, PPU display 102 may display alphanumeric characters relating to the price-per-unit of the fuel for the particular octane. For example, PPU display 102 may read “$3.99” which may indicate that the price of fuel of a particular octane is $3.99 per gallon. This data may be constantly displayed so that the customer can tell how much each octane level costs.

Indicator display 408 provides an indication of some condition such as octane selection or fueling in progress. In this regard, the entirety of indicator display 408 may activate, or only one or more portions of display 408 may activate. Additionally, indicator display 408 may activate in a pattern, such as blinking, if desired.

In this embodiment, display module 400 includes a tail portion 410 which electrically connects the module with control system 42. For example, tail portion 410 may include electrical contacts 602 which allow the module to be “plugged-in” or otherwise electrically connected to a printed circuit board. Electrical contacts 602 may provide power, ground, and a series of data connections to the display areas of module 400. The data provided over contacts 602 may relate to the price-per-unit data to be displayed in the PPU display 102, indicator display data indicating whether and how to activate indicator display 408, and gradeselect display data indicating whether and how to activate gradeselect display 404 (and/or the particular information to display in gradeselect display 404).

FIG. 7 illustrates various layers of display module 400 according to an embodiment. Barrier 702 provides a housing for electrophoretic display panel 706. As shown, display panel 706 is sandwiched between barrier 702 and a backplane 708. A dielectric layer 712 is also disposed between backplane 708 and barrier 702. Barrier 702 is configured to have window areas so that electrophoretic display panel 706 is viewable outside of barrier 702. A stiffener member 710 is adhered to tail portion 410 via an adhesive to provide rigid support for tail portion 410.

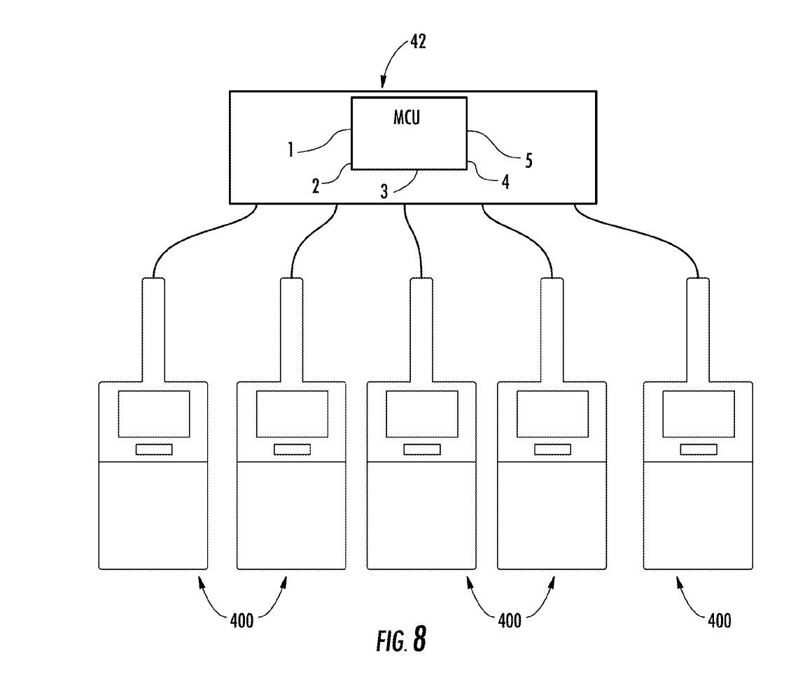

Control system 42 may control the displays of each display module 400. As illustrated in FIG. 8, multiple display modules 400 may be connected to the same control system 42. Each display module 400 is associated with a different grade or type of fuel such that when a customer activates one display module 400, control system 42 receives such input and identifies that the customer has selected the octane grade or type associated with the selected display module. In this regard, the display module associated with the selected grade or type may be activated (e.g., the electrophoretic displays of the selected display module are activated) and all other display modules are deactivated. As a result, the customer immediately recognizes that the customer has selected one grade or type of fuel for dispensing.

Referring again to FIG. 5, overlay 402 is juxtaposed to the corresponding display module 400 so that overlay 402 is viewable by the customer when selecting an octane grade or type of fuel. As shown, overlay 402 includes a body portion 426 which may be formed of a clear polymeric sheet (such as plexiglas) that is printed in certain areas with the desired graphics. For example, the graphics layer may define clear windows 420, 422 and translucent area 424. It will be appreciated that window 420 aligns with PPU display 102 of display module 400. Display window 422 aligns with indicator display 408 of display module 400. Translucent area 424 aligns with gradeselect display 404 of display module 400. As a result of this configuration, displays 102 and 408 show directly through windows 420 and 422.

In this embodiment, when display 404 is activated, translucent area 424 will change in appearance (such as becoming darker than before) to affirm the selection made by the customer. The remaining portion of overlay 402 may be opaque. For example, area 424 may be translucent yellow with other areas of overlay 402 being opaque green. Text on areas of panel 402 outside of windows 420 and 422 may be another color (such as black or white) and may be translucent or opaque depending on the embodiment. One skilled in the art will recognize that module 400 may be equipped with different or additional displays depending on the desired functionality. For example, a display may be provided behind the grade select text (e.g., “Supreme”) of overlay 402. If this text is formed as clear (or, for example, translucent white) the text will change in appearance when the underlying display is activated. This provides an additional indication of the grade selection.

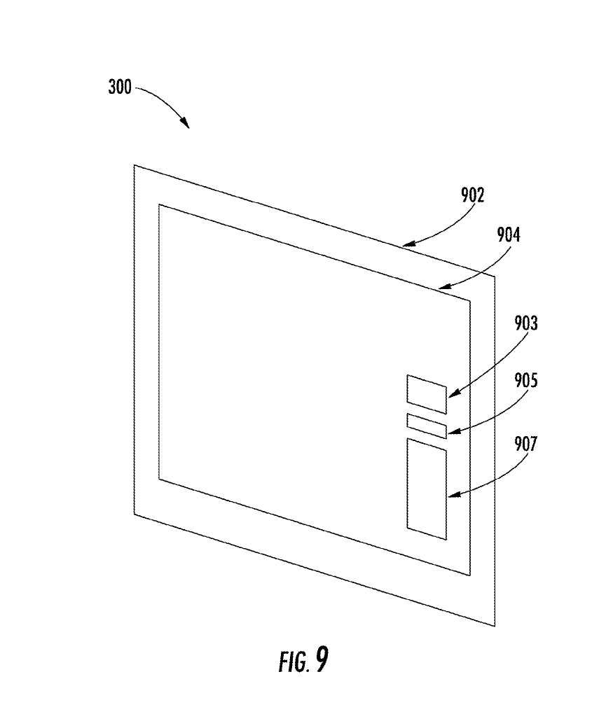

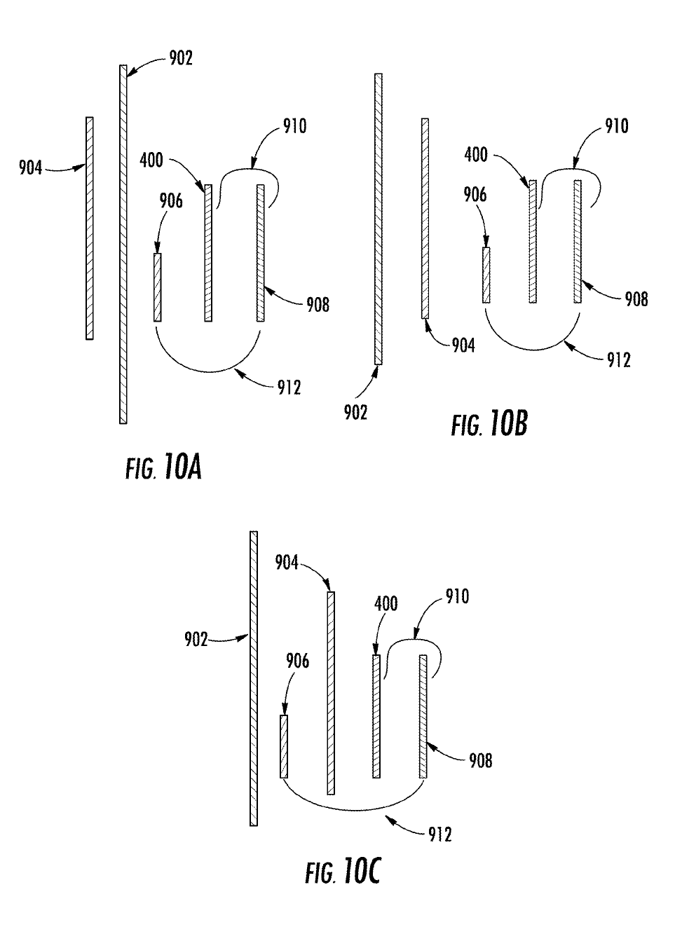

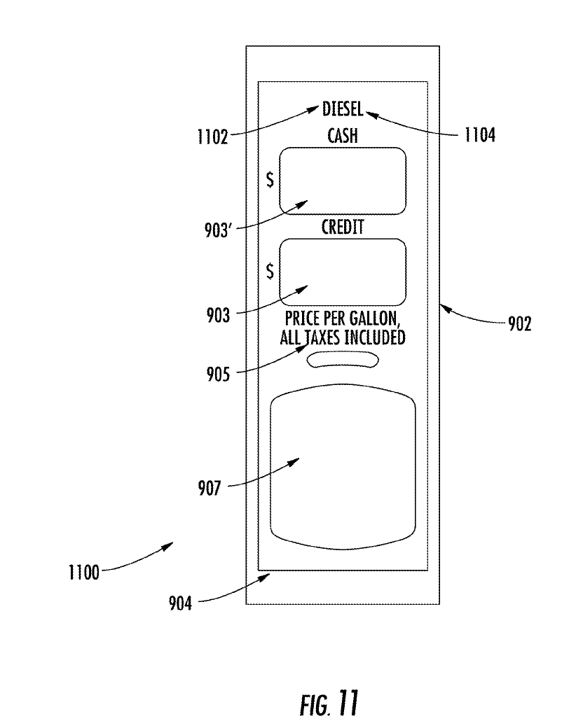

FIG. 9 is a diagrammatic representation of grade select assembly 300 according to an embodiment of the present invention. In this embodiment, assembly 300 is shown with a single grade selector although one skilled in the art will recognize that multiple grade selectors will often be provided. FIGS. 10A-10C illustrate respective exploded side views of layers of grade select assembly 300 according to some embodiments. The composition and configuration of grade select assembly 300 (according to some embodiments) is, therefore, discussed below with reference to FIGS. 9 and 10A-10C.

In the illustrated embodiment, grade select assembly 300 includes a plexiglas frame 902 and a graphic layer 904 defining price-per-unit display window 903, indicator display window 905, and gradeselect display area 907. As shown in FIGS. 10A-C, located behind frame 902 are a touch screen panel device that forms a layer 906, display module 400, and electronic circuit board(s) 908. The graphic layer 904 may be printed directly on frame 902, or it may be a separate substrate carrying the desired graphics. The various layers may be connected together via any suitable means, such as by glue or fasteners.

It will be appreciated that plexiglas frame 902 may serve as a foundation and structural support for the other components of grade select assembly 300. Frame 902 may be of a size having a length and width greater than the length and width of the other components of gradeselect assembly 300.

Graphic layer 904 provides graphics related to the gradeselect button. As described above, these graphics may include the grade or type of the fuel associated with the grade select button. For example, graphics layer 904 may be printed on all areas of the plexiglass frame except for predetermined areas, such as the display windows and other areas which may convey information to the customer. Some printed areas of graphics layer 904 may be translucent, with others opaque. Another embodiment of the graphics layer is discussed in later with respect to FIG. 11.

Price-per-unit display window 903 and indicator display window 905 are preferably clear areas in graphics layer 904. This allows the customer operating the dispenser 34 to be able to view certain areas of display module 400, such as the price-per-unit display and the indicator display, respectively.

In exemplary embodiments, touch screen layer 906 may comprise a capacitive touch screen which detects a change in capacitance when a user touches the outermost layer of assembly 300. For example, touch screen layer 906 may be used herein to implement a grade select feature. In this case, layer 906 will preferably include a clear area juxtaposed in front of the grade select display of module 400. In this manner, activation of the grade select display will show through touch screen 906 and will be seen at grade select display area 907. Moreover, a customer touching grade select display area 907 will be detected by the underlying touch screen to register the selection that was made. As a result, control system 42 identifies the grade or type of fuel to dispense and initiates dispensing of such identified fuel.

It will be appreciated that the need for a mechanical button to perform the grade select function is completely eliminated. As mentioned above, control system 42 may deactivate, or activate differently, other selectors corresponding to fuel grades that were not selected by the customer. For example, electrophoretic displays of the non-selected assemblies 300 may be turned a different shade or color (e.g., from dark to light, black to white, etc.) than the electrophoretic displays of the selected assembly 300.

Board 908 includes components that control and drive display module 400. For example, circuit board 908 may include a processor, memory and logic. The processor executes instruction commands stored in memory. Logic provides the instruction commands to memory in response to the occurrence of certain predefined stimulus. For example, if a customer activates a grade selector, the logic receives such selection and activates the corresponding display module. In addition, circuit board 908 provides electronic communication with control system 42. In the embodiments of FIGS. 10A-C, electronic circuit board 908 is layered with the other layers of assembly 300. Embodiments are contemplated, however, in which circuit board 908 is located separately.

It should be understood that various configurations of grade select assembly 300 are possible. In FIG. 10A, for example, graphic layer 904 is located in front of frame 902. Touch screen layer 906 is located behind frame 902, as shown. Touch screen layer 906 is in electrical communication with circuit board 908, such as via wiring 912, to transmit signals indicating that a user has physically touched grade select display area 907. In response, circuit board 908 transmits the voltage to logic which translates the voltage to a digital signal indicating that the gradeselect button has been activated. Circuit board 908 then activates the PPU display, indicator display and/or any other display areas of the display module 400.

As shown, display module 400 is sandwiched in this embodiment between touch screen 906 and circuit board 908. Module 400 is in electrical communication with circuit board 908 via wiring 910 or other means. Wiring 910 may carry power and data from circuit board 908 to module 400. Additionally, wiring 910 carries data from circuit board 908 to display module 400. For example, circuit board 908 may transmit data via wiring 910 instructing the displays on display module 400. When module 400 receives signals to activate one or more of its displays, these displays are activated accordingly.

It should be noted that wiring 910 and wiring 912 may comprise a conductive trace, a cable, a wireless signal transmitted between two wireless transceivers, or any other means to electronically transmit data between a component and a circuit board.

Assembly 300 includes suitable mounting structure so that it can be attached and fixed with respect to the fuel dispenser housing. In addition, circuit board 908 is suitably connected to a power source within the fuel dispenser. As previously mentioned, circuit board 908 preferably provides power and data links to module 400 and touch screen layer 906.

FIGS. 10B and 10C illustrate side views of grade select assembly 300 according to other embodiments. FIG. 10B is similar to FIG. 10A except that graphic layer 904 is adhered to the backside (instead of the frontside) of plexiglass frame 902.

In FIG. 10C, plexiglass frame 902 is on the outside of grade select assembly 300. Touch screen 906 is located behind frame 902 with graphics layer 904 being sandwiched between touch screen 906 and module 400. Circuit board 908 is located behind module 400. Wiring 912 extends from touch screen 906 to circuit board 908. In this embodiment, frame 902 will be the only layer between the user and touch screen 906.

FIG. 11 illustrates a front view of a grade select assembly 1100 according to another embodiment. As illustrated, grade select assembly 1100 includes plexiglass frame 902 with a graphics layer 904 that defines two PPU windows 903, 903′ (for “credit” or “cash,” respectively), an indicator display window 905, gradeselect window 907 and fuel type indicator window 1102.

Plexiglass frame 902 and graphics layer 904 are similar to those discussed above in relation to FIGS. 9 and 10A-C. As illustrated, graphics layer 904 covers all areas of frame 902 except for the clear window areas of PPU windows 903, 903′, indicator display window 905, gradeselect window 907 and fuel type indicator window 1102. The graphics may be opaque or translucent. In an embodiment where all graphics are opaque, the customer of the fuel dispenser cannot substantially visually perceive any portion of the underlying module except those viewable through the clear windows.

In an embodiment where at least some of the graphics layer is translucent, the printed graphics in such areas can change in appearance (such as becoming a darker shade) when activated. For example, such areas may be activated in a pattern (e.g., flashing) or presented constantly “on” when the associated display module 400 has been activated.

As shown, fuel type indicator window 1102 outlines lettering reflecting the type or grade of fuel associated with assembly 1100 (e.g., “diesel”). A display area 1104 of the underlying display module is aligned with the fuel type indicator window 1102 and is viewable therethrough. As such, when display area 1104 is activated, the word “DIESEL” will appear different from fuel type indicator windows associated with other available grades or type of fuel.

It can thus be seen that the present invention provides a novel grade select assembly for use with a fuel dispenser. While one or more preferred embodiments of the invention have been described above, it should be understood that any and all equivalent realizations of the present invention are included within the scope and spirit thereof. The embodiments depicted are presented by way of example only and are not intended as limitations upon the present invention. Thus, it should be understood by those of ordinary skill in this art that the present invention is not limited to these embodiments since modifications can be made. Therefore, it is contemplated that any and all such embodiments are included in the present invention as may fall within the scope and spirit thereof.

What is claimed is:

1. A selector assembly for a fuel dispenser, comprising:
an electrophoretic display module including a price per unit display configured to display price per unit data;
an overlay adjacent to the electrophoretic display module so that the overlay is viewable by a user, the overlay defining a transparent price per unit window aligned with the price per unit display and further having a grade select button area; and
a touch screen panel aligned with the button area of the overlay to detect user selection of a corresponding fuel grade or type.

2. A selector assembly as set forth in claim 1, wherein said electrophoretic display module comprises a grade select display aligned with the grade select button area, said grade select display being operative to change state in response to detection of user selection by said touch screen panel.

3. A selector assembly as set forth in claim 2, wherein said grade select button area defines a grade window to show therethrough fuel grade or type information appearing on said grade select display.

4. A selector assembly as set forth in claim 3, wherein said grade select display shows alphanumeric information through said grade window indicating said fuel grade or type.

5. A selector assembly as set forth in claim 3, wherein said grade window defines alphanumeric characters which show therethrough a change of state of said grade select display, said change of state comprising said fuel grade or type information.

6. A selector assembly as set forth in claim 2, wherein said grade select button area includes graphics indicative of a corresponding fuel grade or type, and is at least in part translucent so that said grade select display is operative to affirm user selection via change of state of said grade select display.

7. A selector assembly as set forth in claim 1, wherein said electrophoretic display module, said overlay, and said touch screen panel are sandwiched together.

8. A selector assembly as set forth in claim 7, wherein said touch screen panel is situated between said overlay and said electrophoretic display module.

9. A selector assembly as set forth in claim 8, wherein said touch screen panel comprises a capacitive touch screen device.

10. A selector assembly as set forth in claim 1, further comprising a circuit board juxtaposed to at least one of said electrophoretic display module, said overlay, and said touch screen panel, said circuit board being in electrical communication with said electrophoretic display module and said touch screen panel.

11. A selector assembly as set forth in claim 1, wherein the electrophoretic display module further comprises an indicator display, and wherein the overlay further comprises a transparent indicator display window aligned with the indicator display.

12. A selector assembly as set forth in claim 1, wherein said overlay is configured to be transparent, translucent, and opaque in different areas thereof.

13. A selector assembly as set forth in claim 1, having a plurality of said price per unit displays and said grade select button areas corresponding to respective fuel grades or types.

14. A selector assembly for a fuel dispenser, comprising:
an electrophoretic display module including a grade select display;
an overlay adjacent to the electrophoretic display module so that the overlay is viewable by a user, the overlay defining a grade select button area aligned with said grade select display;
a generally flat selection device sandwiched between said grade select display and said grade select button area to detect user selection of a corresponding fuel grade or type; and
wherein said grade select display is operative to change state in response to detection of user selection by said selection device.

15. A selector assembly as set forth in claim 14, wherein said generally flat selection device comprises a touch screen panel.

16. A selector assembly as set forth in claim 14, wherein said grade select button area defines a transparent grade window to show therethrough fuel grade or type information appearing on said grade select display.

17. A selector assembly as set forth in claim 16, wherein said grade select display shows alphanumeric information through said grade window indicating said fuel grade or type.

18. A selector assembly as set forth in claim 16, wherein said grade window defines alphanumeric characters which display a change of state of said grade select display, said change of state comprising said fuel grade or type information.

19. A selector assembly as set forth in claim 14, wherein said grade select button area includes graphics indicative of the corresponding fuel grade or type, and is at least in part translucent so that said grade select display is operative to affirm the user selection via change of state of said grade select display.

20. A selector assembly as set forth in claim 19, wherein:
said electrophoretic display module further includes a price per unit display configured to display price per unit data; and
said overlay defines a transparent price per unit window aligned with said price per unit display.

21. A selector assembly as set forth in claim 14, further comprising a circuit board juxtaposed to at least one of said electrophoretic display module, said overlay, and said selection device, said circuit board being in electrical communication with said electrophoretic display module and said selection device.

22. A selector assembly as set forth in claim 14, wherein the electrophoretic display module further comprises an indicator display, and wherein the overlay further comprises a transparent indicator display window aligned with the indicator display.

23. A selector assembly as set forth in claim 14, wherein said overlay is configured to be transparent, translucent, and opaque in different areas thereof.

24. A selector assembly as set forth in claim 14, having a plurality of said grade select button areas corresponding to respective fuel grades or types.

25. A fuel dispenser comprising:
a housing having a user interface;
said housing enclosing fuel handling components including a fluid flow meter and a pulser operatively connected to said fluid flow meter;
a control system in electrical communication with said pulser and said user interface; and
said user interface including a plurality of grade selectors corresponding to respective fuel grades or types, each of said grade selectors including:
an electrophoretic display module including a grade select display;
a touch screen panel adjacent to said grade select display of said electrophorectic display module to detect user selection of the corresponding fuel grade or type;
said grade selector being operative to provide information indicative of the user selection to the control system; and
wherein said grade select display of the electrophoretic display module is operative to change state in response to detection of user selection by said touch screen panel.

26. A fuel dispenser as set forth in claim 25, wherein each of said grade selectors comprises an overlay adjacent to said electrophoretic display module so that the overlay is viewable by a user, the overlay defining a grade select button area aligned with said grade select display.

27. A fuel dispenser as set forth in claim 26, wherein said grade select button area defines a transparent grade window to show therethrough fuel grade or type information appearing on said grade select display.

28. A fuel dispenser as set forth in claim 27, wherein said grade select display shows alphanumeric information through said grade window indicating said fuel grade or type.

29. A fuel dispenser as set forth in claim 27, wherein said grade window defines alphanumeric characters which display a change of state of said grade select display, said change of state comprising said fuel grade or type information.

30. A fuel dispenser as set forth in claim 26, wherein said grade select button area includes graphics indicative of the corresponding fuel grade or type, and is at least in part translucent so that said grade select display is operative to affirm the user selection via change of state of said grade select display.

31. A fuel dispenser as set forth in claim 26, wherein:
said electrophoretic display module further includes a price per unit display configured to display price per unit data; and
said overlay defines a transparent price per unit window aligned with said price per unit display.

32. A method of operating a fuel dispenser, said method comprising steps of:
providing a selector assembly including:
a selection device;
an electrophoretic display module having a price per unit display; and
an overlay having a price-per-unit window and a grade select area, said overlay being adjacent to the selection device and the electrophoretic display module so that the price-per-unit window is aligned with the price per unit display and the grade select area is aligned with the selection device;
receiving input at a processor indicating that a user of the fuel dispenser has activated the selection device;
transmitting, by operation of the processor, price per unit data to the electrophoretic display module in response to the receiving input step; and
displaying, at the price per unit display, the price per unit data.

33. A method as set forth in claim 32, wherein said electrophoretic display module further includes a grade select display aligned with the grade select area of the overlay and the selection device, said grade select display being operative to change state in response to detection of user selection at the selection device.

34. A method as set forth in claim 33, wherein said grade select button area defines a grade window to show therethrough fuel grade or type information appearing on said grade select display.

35. A method as set forth in claim 34, wherein said grade select display shows alphanumeric information through said grade window indicating said fuel grade or type.

36. A method as set forth in claim 34, wherein said grade window defines alphanumeric characters which display a change of state of said grade select display, said change of state comprising said fuel grade or type information.

37. A method as set forth in claim 33, wherein said grade select button area includes graphics indicative of the corresponding fuel grade or type, and is at least in part translucent so that said grade select display is operative to affirm user selection via change of state of said grade select display.
